(19) United States
(12) Patent Application Publication
(10) Pub. No.: US 2014/0029260 A1
(43) Pub. Date: Jan. 30, 2014

(54) LIGHTING DEVICE

(71) Applicant: Funai Electric Co., Ltd., Osaka (JP)

(72) Inventor: Minghui LIU, Osaka (JP)

(73) Assignee: FUNAI ELECTRIC CO., LTD.

(21) Appl. No.: 13/938,844

(22) Filed: Jul. 10, 2013

(30) Foreign Application Priority Data
Jul. 30, 2012 (JP) 2012-168806

(51) Int. Cl. F21V 21/00

(52) U.S. Cl. CPC F21V 21/00
USPC 362/249.02; 362/249.01

(57) ABSTRACT

A lighting device includes a lighting unit and a frame. The lighting unit has at least one light emitting unit with light emitting elements. The frame sandwiches outer edges of the lighting unit to support the lighting unit.

### CROSS-REFERENCE TO RELATED APPLICATIONS

This application claims priority to Japanese Patent Application No. 2012-168806 filed on Jul. 30, 2012. The entire disclosure of Japanese Patent Application No. 2012-168806 is hereby incorporated herein by reference.

### BACKGROUND

1. Field of the Invention

The present invention generally relates to a lighting device. More specifically, the present invention relates to a lighting device in which a light emitting unit is supported by a frame.

2. Background Information

A lighting device in which light emitting components are supported by a frame is well-known (see Japanese Laid-Open Patent Application Publication No. 2012-38532 (Patent Literature 1), for example).

The above-mentioned Patent Literature 1 discloses a lighting device used to light a tunnel. The lighting device has a plurality of LED units (light emitting units) each having a plurality of LED modules, and a box-like main body (frame) to which the LED units are fixedly attached. The LED units include metal plates on which the LED modules are installed. These metal plates are installed on a surface of the box-like main body. The metal plates are fastened by a plurality of (six) bolts, thereby attached to the box-like main body. With the lighting device in Patent Literature 1, four LED units are each attached by six bolts to the box-like main body.

### SUMMARY

With the lighting device discussed in Patent Literature 1, each of the LED units has to be bolted down with six bolts in order to attach the LED units (light emitting units) to the box-like main body (frame). It has been discovered that numerous bolts are required to attach the LED units, which increases the number of parts of the lighting device. Furthermore, it has also been discovered that since this entails the work of using these bolts to fasten the LED units to the box-like main body, the assembly work is more complicated.

One object of the present disclosure is to provide a lighting device with which an increase in the number of parts is avoided and the work entailed by assembling the lighting device is simplified.

In view of the state of the know technology, a lighting device includes a lighting unit and a frame. The lighting unit has at least one light emitting unit with light emitting elements. The frame sandwiches outer edges of the lighting unit to support the lighting unit.

Other objects, features, aspects and advantages of the present disclosure will become apparent to those skilled in the art from the following detailed description, which, taken in conjunction with the annexed drawings, discloses a preferred embodiment of a lighting device.

### BRIEF DESCRIPTION OF THE DRAWINGS

Referring now to the attached drawings which form a part of this original disclosure:

FIG. 1 is a front perspective view of a lighting device in accordance with one embodiment;

FIG. 2 is a side elevational view of the lighting device illustrated in FIG. 1;

FIG. 3 is an exploded rear perspective view of the lighting device illustrated in FIG. 1;

FIG. 4 is a cross sectional view taken along 500-500 line in FIG. 1;

FIG. 5 is a front plan view of the lighting device illustrated in FIG. 1, with the lighting device partially removed to show linkages of a frame of the lighting device and engagements of the frame and light emitting units of the lighting device;

FIG. 6 is an enlarged, partial cross sectional view illustrating the engagements of the frame and the light emitting units illustrated in FIG. 5;

FIG. 7 is a front plan view of a lighting device with light emitting units arranged in one row and in two columns in accordance with a modified example, with the lighting device partially removed to show linkages of a frame of the lighting device and engagements of the frame and the light emitting units;

FIG. 8 is a front plan view of a lighting device with a light emitting unit arranged in one row and in one column in accordance with a modified example, with the lighting device partially removed to show linkages of a frame of the lighting device and engagements of the frame and the light emitting unit;

FIG. 9 is a front plan view of a lighting device with light emitting units arranged in two rows and in three columns in accordance with a modified example, with the lighting device partially removed to show linkages of a frame of the lighting device and engagements of the frame and the light emitting units;

FIG. 10 is a front plan view of a lighting device with light emitting units arranged in one row and in three columns in accordance with a modified example, with the lighting device partially removed to show linkages of a frame of the lighting device and engagements of the frame and the light emitting units;

FIG. 11(a) is a front plan view of a lighting device with light emitting units arranged in two rows and in two columns in accordance with a modified example, with the lighting device partially removed to show linkages of a frame of the lighting device and engagements of the frame and the light emitting units; and

FIG. 11(b) is a front plan view of a lighting device with a light emitting unit arranged in one row and in one column in accordance with a modified example, with the lighting device partially removed to show linkages of a frame of the lighting device and engagements of the frame and the light emitting unit.

### DETAILED DESCRIPTION OF EMBODIMENTS

A preferred embodiment will now be explained with reference to the drawings. It will be apparent to those skilled in the art from this disclosure that the following descriptions of the embodiment are provided for illustration only and not for the purpose of limiting the invention as defined by the appended claims and their equivalents.

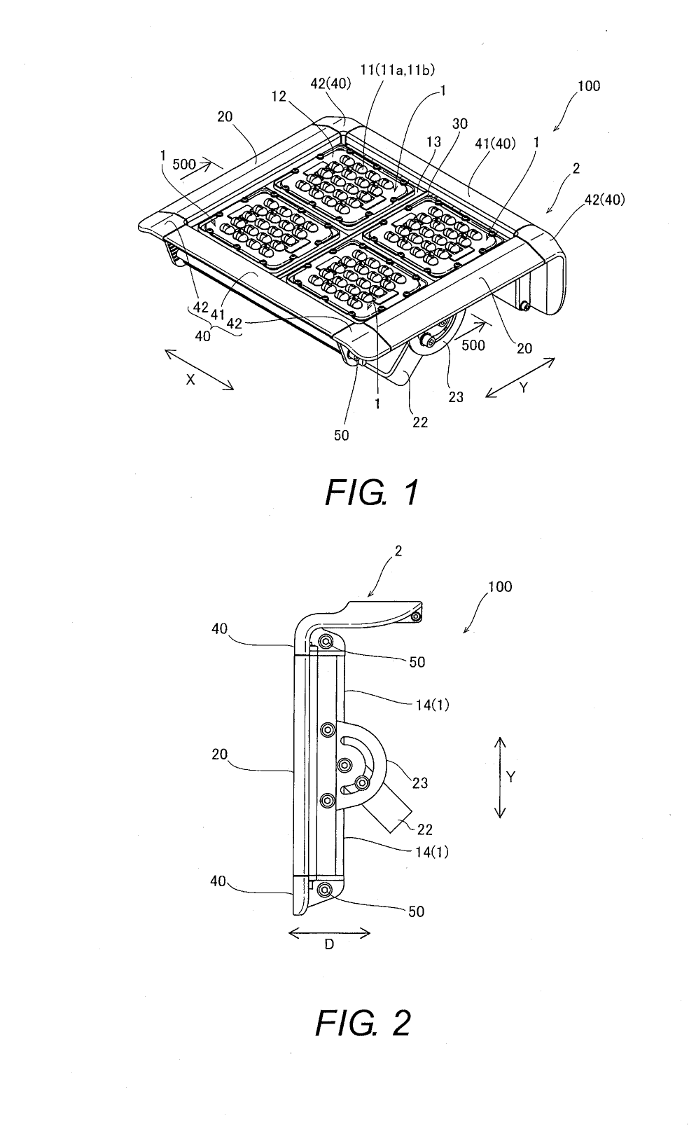

Referring initially to FIGS. 1 to 6, a lighting device 100 is illustrated in accordance with one embodiment. In the illustrated embodiment, the lighting device 100 is used to light a tunnel.

As shown in FIGS. 1 and 2, the lighting device 100 mainly includes a lighting unit having a plurality of (four in FIG. 1) light emitting units 1 (e.g., at least one light emitting unit), and a frame 2 sandwiching and supporting outer edges of the lighting unit. In the illustrated embodiment, the lighting unit is formed by the four light emitting units 1 arranged in two rows and in two columns. In the illustrated embodiment, the outer edges of the lighting unit are defined by portions of an outer periphery of the four light emitting units 1 arranged in two rows and in two columns. In particular, in the illustrated embodiment, the outer edges of the lighting unit are defined by top edges of the light emitting units 1 arranged in the top row and bottom edges of the light emitting units 1 arranged in the bottom row. However, alternatively, the outer edges of the lighting unit can be defined by right edges of the light emitting units 1 arranged in the right column and left edges of the light emitting units 1 arranged in the left column. On the other hand, the frame 2 is engaged with outer engagement edges of the lighting unit. In the illustrated embodiment, the outer engagement edges of the lighting unit are defined by portions of the outer periphery of the four light emitting units 1 arranged in two rows and in two columns. In particular, in the illustrated embodiment, the outer engagement edges of the lighting unit are defined by right edges of the light emitting units 1 arranged in the right column and left edges of the light emitting units 1 arranged in the left column. However, alternatively, the outer engagement edges of the lighting unit can be defined by top edges of the light emitting units 1 arranged in the top row and bottom edges of the light emitting units 1 arranged in the bottom row.

The lighting device 100 in this embodiment is used to light a tunnel. The lighting device 100 is configured so that an attachment component 22 whose angle is adjustable can be attached to the wall, ceiling, etc. of a tunnel (not shown) for use. As discussed below, the lighting device 100 can also be configured such that the number of light emitting units 1 is freely adjusted by replacing parts of the frame 2 (first frame parts 20 and straight sections 41 of second frame parts 40). Consequently, the amount of light obtained varies with the number of the light emitting units 1. Thus, it is possible to configure the lighting device 100 suitably according to the installation location in the tunnel, the tunnel specifications, and so forth. As shown in FIGS. 1 to 6, with the lighting device 100, four light emitting units 1 are laid out in a rectangular shape formed by two units each (two rows and two columns) in the X direction (lateral direction) and the Y direction (longitudinal direction).

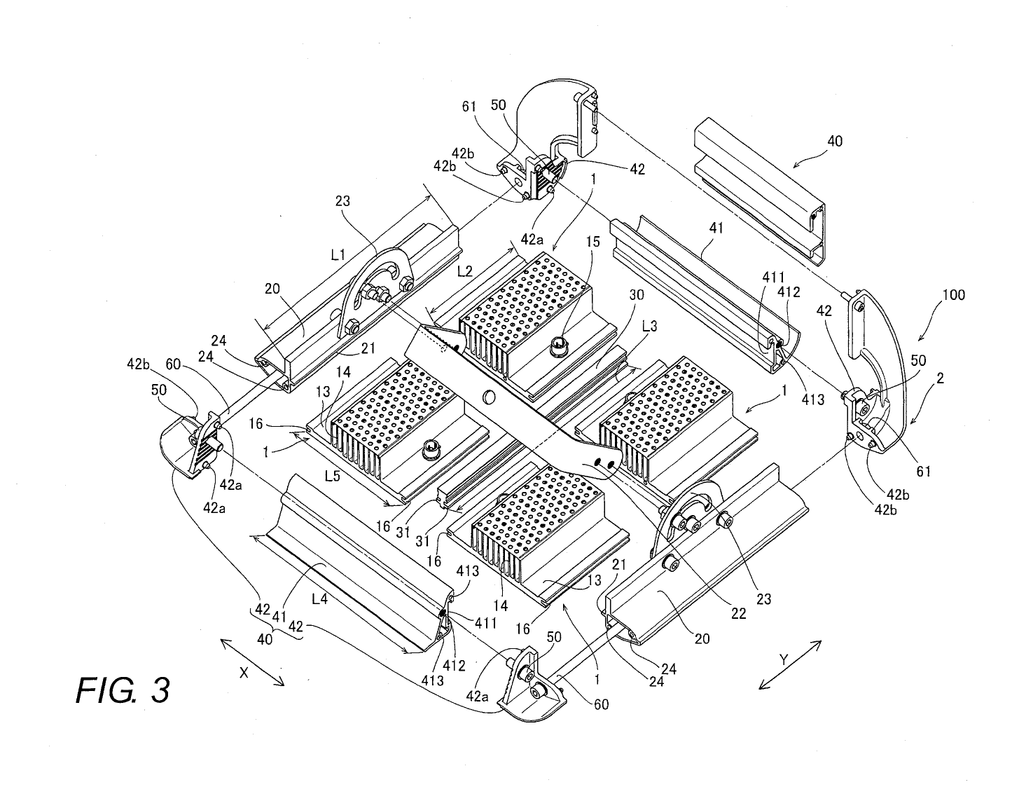

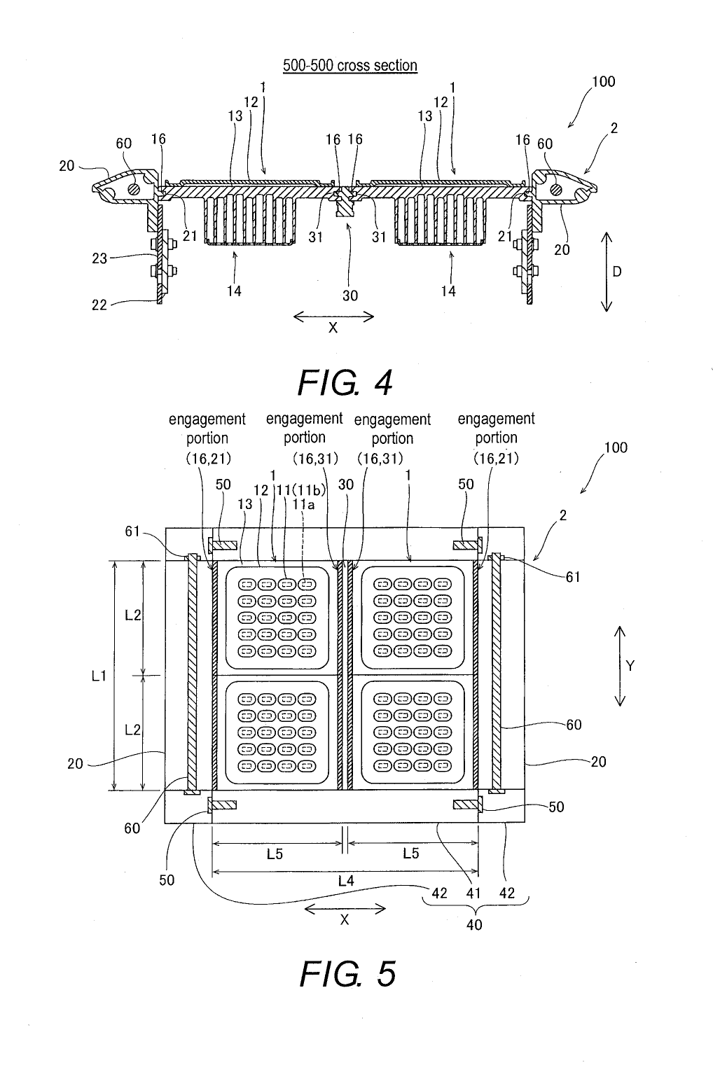

As shown in FIGS. 1 to 4, the light emitting units 1 each include a plurality of light emitting components 11, a substrate 12 to which the light emitting components 11 are mounted, a support member 13 (see FIGS. 3 and 4) that supports the substrate 12 on the front side, and heat dissipating fins 14 (see FIGS. 3 and 4) that is disposed on the rear side of the support member 13. The X direction is an example of the “first direction” of the present invention, while the Y direction is an example of the “second direction” of the present invention.

As shown in FIG. 1, the light emitting components 11 are laid out in a matrix on the surface of the rectangular substrate 12. In this embodiment, twenty of the light emitting components 11 are provided in five rows and four columns on the substrate 12. As shown in FIG. 5, the twenty light emitting components 11 each have an LED element 11a and a dome-shaped (see FIG. 1) diffuser lens 11b that covers the LED element 11a. Each of the LED elements 11a is connected to a circuit component (not shown) formed on the substrate 12, and is configured to emit light when power is supplied through a power connector 15 (see FIG. 3). The LED elements 11a are an example of the “light emitting element” of the present invention.

As shown in FIGS. 3 and 4, the support member 13 is made of aluminum and supports the substrate 12 on its front side. When viewed from the front, the support member 13 has a rectangular shape that is larger than the substrate 12. The heat dissipating fins 14 are formed integrally on the rear side of the support member 13 (the opposite side from the substrate 12). The support member 13, along with the heat dissipating fins 14, has the function of dissipating heat generated as light is emitted from the light emitting unit 1. In this embodiment, the support member 13 and the heat dissipating fins 14 are formed integrally from aluminum, which is lightweight and has excellent thermal conductivity, as a one-piece, unitary member. However, the support member 13 and the heat dissipating fins 14 can be independently formed as separate members.

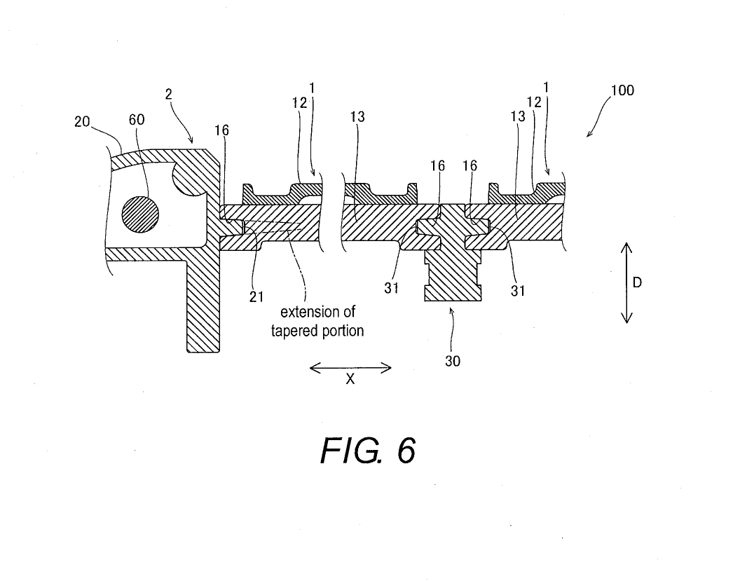

In this embodiment, female components (grooves) 16 are formed in the support member 13 at the end faces (outer edges) on both sides in the X direction (lateral direction). The female components 16 are formed so as to extend in the Y direction (longitudinal direction) along outer edges of each of the light emitting units 1 (outer edges of the support member 13 or outer engagement edges of the lighting unit). The female components 16 are provided over the entire end faces of the support member 13 on both sides in the X direction. Specifically, the female components 16 extend to both ends of the support member 13 in the Y direction. As shown in FIG. 6, the female components 16 have a tapered cross sectional shape that gradually narrows in width toward the bottom. The female components 16 are an example of the “first engagement components” of the present invention.

As shown in FIGS. 1 and 3, the frame 2 includes a pair of first frame parts 20 and a pair of second frame parts 40. The first frame parts 20 are disposed on both sides in the X direction with respect to the four light emitting units 1 (i.e., the lighting unit). The second frame parts 40 are disposed on both sides in the Y direction with respect to the four light emitting units 1 (i.e., the lighting unit). The frame 2 further includes a linking component 30 (see FIG. 3). The linking component 30 is disposed between an adjacent pair of the light emitting units 1 that is aligned in the X direction. The linking component 30 is an example of the “linking frame” of the present invention. The first and second frame parts 20 and 40 are examples of the “frame parts” of the present invention.

The frame 2 has a rectangular shape in which the first frame parts 20 and the second frame parts 40 surround the outer edges of the four light emitting units 1 arranged in a rectangular shape (i.e., the outer edges and outer engagement edges of the lighting unit). The frame 2 is configured so as to sandwich and support the outer edges of the four light emitting units 1 (i.e., the lighting unit) from the outside. In this embodiment, the frame 2 supports the four light emitting units 1 (i.e., the lighting unit) by having the pair of the second frame parts 40 linked to each other so that the outer edges of the four light emitting units 1 (i.e., the outer edges of the lighting unit) are sandwiched from the outside in the Y direction. In other words, the frame 2 supports the four light emitting units 1 (i.e., the lighting unit) by pressing the pair of second frame parts 40 inward in the Y direction. The frame 2 (the first frame parts 20, the second frame parts 40, and the linking component 30) is made of aluminum as are the support members 13 of the light emitting units 1.

As shown in FIGS. 3 and 4, the first frame parts 20 have a hollow cylindrical shape that extends linearly in the Y direction. As shown in FIG. 5, the length L1 of the first frame parts 20 in the Y direction corresponds to the overall length of the arranged light emitting units 1. Specifically, with the layout pattern of two rows and two columns of light emitting units 1, the length L1 of the first frame parts 20 corresponds to two times the length L2 of the light emitting units 1 in the Y direction (L1≈2×L2).

As shown in FIGS. 3 and 6, in this embodiment, male components 21 extending in the Y direction are integrally formed on the inner surfaces in the X direction of the pair of first frame parts 20. The male components 21 are provided so as to correspond to the female components 16 of the light emitting units 1. The male components 21 are formed linearly over the entire length of the first frame parts 20 in the Y direction, respectively. These male components 21 engage with the female components 16 of the support member 13 in the X direction. In FIG. 5, the engagement portions between the male components 21 and the female components 16 are indicated with narrow hatching. The male components 21 are an example of the “second engagement components” of the present invention.

As shown in FIG. 6, the male components 21 have a tapered cross sectional shape that corresponds to the tapered cross sectional shape of the female components 16. Specifically, the male components 21 have the tapered cross sectional shape that gradually narrows toward the top. This allows the male components 21 of the first frame parts 20 to mate with the female components 16 of the support member 13 such that the surfaces of the male components 21 and the surfaces of the female components 16 are in planar contact.

As shown in FIG. 3, both distal ends of the U-shaped attachment component 22 are attached to the pair of first frame parts 20. Also, angle adjusting mechanisms 23 are attached one each to the pair of first frame parts 20, allowing the attachment angle of the lighting device 100 (the attachment component 22) to be adjusted and kept at a specific angle.

As shown in FIGS. 3 and 5, the linking component 30 extends in the Y direction between the light emitting units 1 arranged in the X direction. As shown in FIG. 3, the linking component 30 is also formed in a length in the Y direction corresponding to the overall length of the arranged light emitting units 1, just as the first frame parts 20 are. In this embodiment, the linking component 30 has a length L3 that is slightly greater than the length L1 of the first frame parts 20 (L3>2×L2). Consequently, the linking component 30 protrudes slightly at both ends in the Y direction with respect to the first frame parts 20. These ends of the linking component 30 engage with the second frame parts 40 by fitting into grooves 411 formed in the second frame parts 40.

Male components 31 that are the same as the male components 21 of the first frame parts 20 are provided on both side faces of the linking component 30 in the X direction. The male components 31 are formed so as to extend along the entire length in the Y direction. The linking component 30 is engaged in the X direction with the female components 16 of the light emitting units 1 on both sides in the X direction by the pair of male components 31 on both side faces. Consequently, adjacent light emitting units 1 are linked by engagement of the linking component 30. Also, the four light emitting units 1 (i.e., the lighting unit) as a whole are engaged with the pair of first frame parts 20 on both sides in the X direction. As a result, relative movement of each of the light emitting units 1 relative to the first frame parts 20 and the linking component 30 is restricted in directions other than the Y direction (such as the X direction and the D direction (thickness direction); see FIG. 2) by engagement of the female components 16 on both sides of the support member 13 with the male components 21 of the first frame parts 20 and the male components 31 of the linking component 30.

As shown in FIG. 6, the male components 31 have the same tapered cross sectional shape as the male components 21 of the first frame parts 20. Therefore, the male components 31 mate with the female components 16 of the light emitting units 1 so that the surfaces of the male components 31 and the surfaces of the female components 16 are in planar contact. In FIG. 5, the engagement portions between the male components 31 and the female components 16 are indicated with narrow hatching. As a result, there is more contact surface area between the light emitting units 1, the first frame parts 20, and the linking component 30, which makes thermal conductivity higher. Consequently, in this embodiment, not just the heat dissipating fins 14 of the light emitting units 1, but the entire frame 2 (the first frame parts 20, the linking component 30, and the second frame parts 40) functions as a heat dissipater.

As shown in FIGS. 1 and 3, the pair of second frame parts 40 each has a straight section 41 extending linearly in the X direction, and a pair of connectors 42 disposed at the ends of the straight section 41 in the X direction.

As shown in FIG. 5, the straight sections 41 have a length L4 corresponding to the overall length of the arranged light emitting units 1 in the X direction. Specifically, with the layout pattern of two rows and two columns of light emitting units 1, the length L4 of the straight sections 41 corresponds to two times the length L5 of the light emitting units 1 in the X direction. More specifically, the length L4 is equivalent to the length in a state in which the light emitting units 1, the first frame parts 20, and the linking component 30 have been engaged (mated) in the X direction in addition to the length of the linking component 30 in the X direction). The grooves 411, into which are fitted the distal ends of the linking component 30, are formed (see FIG. 3) on the inside of the straight sections 41 in the Y direction.

As shown in FIG. 3, the connectors 42 are fastened to the straight sections 41 by bolts 50 that are threaded into screw holes 412 at the ends of the straight sections 41 in the X direction. Protrusions 42a are provided to the connectors 42 at the attachment faces of the connectors 42 attached to the straight sections 41. Holes 413 are provided on the straight section 41 side. The connectors 42 and the straight sections 41 are positioned by fitting the protrusions 42a in the holes 413, respectively.

As shown in FIG. 5, the pair of second frame parts 40 clamps the various components including the light emitting units 1 by being pulled together from both sides in the Y direction in a state of sandwiching the light emitting units 1, the linking component 30, and the pair of first frame parts 20. More specifically, the connectors 42 of the pair of second frame parts 40 are fastened together by long bolts 60 that extend in the Y direction, and nuts 61 that thread onto the bolts 60. These bolts 60 pass through the interior of the hollow first frame parts 20 from the connectors 42 of one of the second frame parts 40, and extend to the connectors 42 of the other one of the second frame part 40, respectively. The bolts 60 thread into the nuts 61 at the connectors 42 on the opposite side. As a result, tightening the bolts 60 and the nuts 61 allows the pair of second frame parts 40 to sandwich and fix the four light emitting units 1, the first frame parts 20, and the linking component 30 from both sides in the Y direction. As a result, tightening the bolts 60 and the nuts 61 links the pair of second frame parts 40 to the pair of first frame parts 20.

As shown in FIG. 3, protrusions 42b are provided on the connectors 42 at the attachment faces of the connectors 42 attached to the first frame parts 20. Holes 24 are provided on the first frame parts 20 side, respectively. The connectors 42 and the first frame parts 20 are engaged by fitting the protrusions 42b into the holes 24. Consequently, the pair of first frame parts 20 is positioned in the X direction by engagement with the connectors 42 at both ends in the Y direction. As discussed above, the length L4 of the straight sections 41 of the second frame parts 40 is set to the length in a state in which the light emitting units 1, the first frame parts 20, and the linking component 30 have been engaged (mated) in the X direction. Therefore, in assembly, as a result of engagement (mating) between the protrusions 42b and the holes 24, the first frame parts 20 are positioned so that the male components 21 and 31 and the female components 16 mate properly (at positions in the X direction). Consequently, proper mating of the male components 21 of the first frame parts 20 with the female components 16 of the light emitting units 1, and proper mating of the female components 16 of the light emitting units 1 with the male components 31 of the linking component 30 are achieved.

Because of the above configuration, with the lighting device 100, the light emitting units 1 are attached to the frame 2 without the use of a unit fixing bolts between the frame 2 and the four light emitting units 1.

A variation on the configuration of the lighting device 100 will now be described.

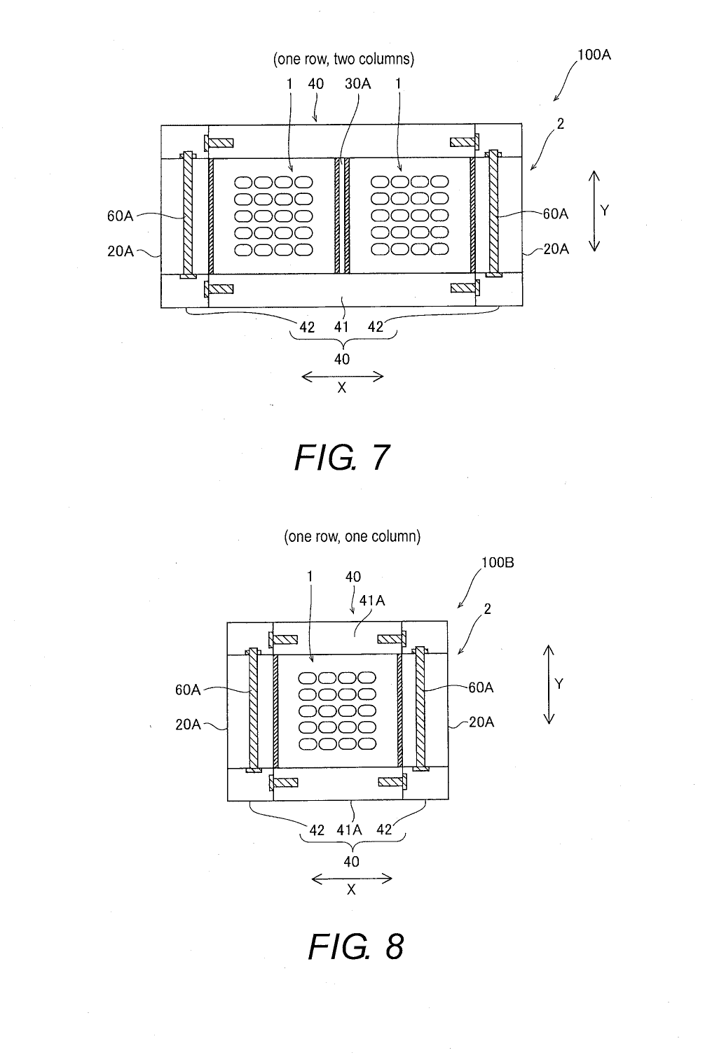

As shown in FIG. 7, a lighting device 100A includes two light emitting units 1 arranged in one row and two columns in the X direction. In this example, the two light emitting units 1 form a lighting unit of the lighting device 100A. As shown in FIG. 7, the lighting device 100A further has the frame 2 sandwiching and supporting outer edges of the lighting unit of the lighting device 100A. The lighting device 100A can be configured merely by providing first frame parts 20A, a linking component 30A, and bolts 60A having a length corresponding to the length L2 of the single light emitting unit 1 in the Y direction (see FIG. 5). In other words, the frame 2 has the second frame parts 40 each having the straight section 41 and the connectors 42 (see FIG. 5).

As shown in FIG. 8, a lighting device 100B includes the single light emitting unit 1. In other words, the lighting device 100B has a layout of one row and one column. In this example, the single light emitting unit 1 forms a lighting unit of the lighting device 100B. As shown in FIG. 8, the lighting device 100B further has the frame 2 sandwiching and supporting outer edges of the lighting unit of the lighting device 100B. With the lighting device 100B, the first frame parts 20A and the bolts 60A are the same as those in the lighting device 100A. The lighting device 100B can be configured merely by providing straight sections 41A having a length corresponding to the length L5 of the single light emitting unit 1 in the X direction (see FIG. 5). In other words, the frame 2 has the second frame parts 40 each having the straight section 41A and the connectors 42 (see FIG. 5). As shown in FIG. 8, when no additional light emitting unit is arranged in the X direction, there is no need to provide a linking component (30A). A possible variation of the second frame parts 40 can be achieved by sharing the connectors 42 and merely changing the length of the straight sections 41.

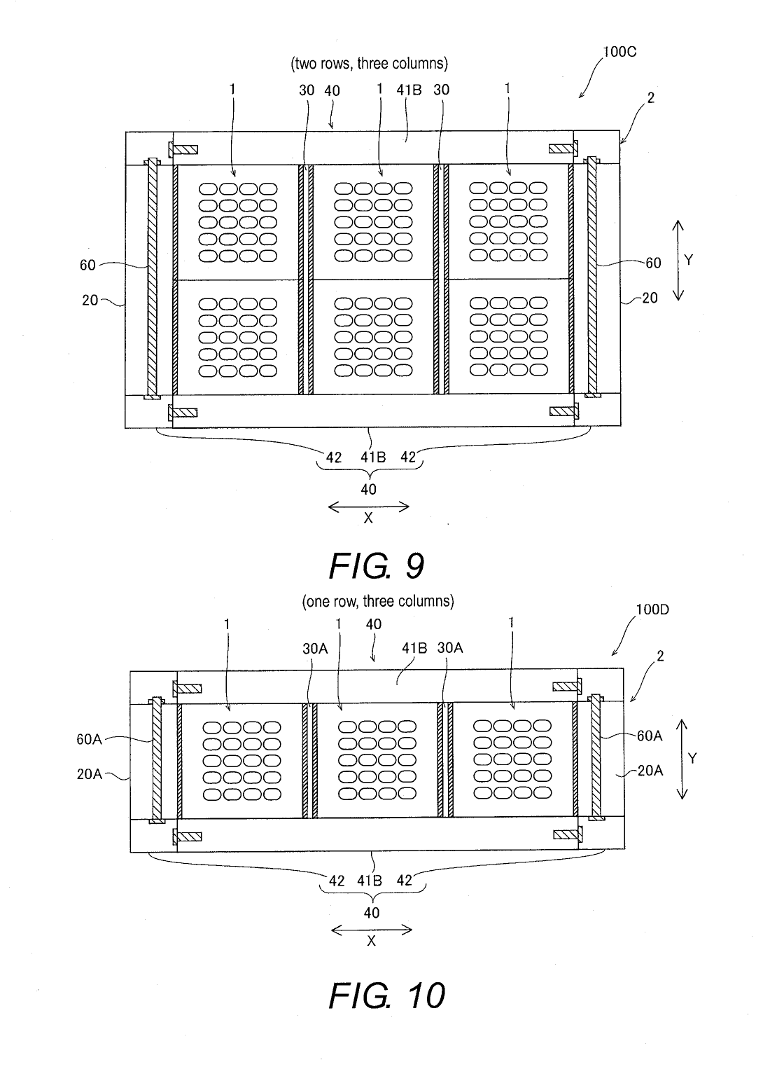

As shown in FIG. 9, a lighting device 100C includes six light emitting units 1 arranged in a layout of two rows and three columns. In this example, the six light emitting units 1 form a lighting unit of the lighting device 100C. As shown in FIG. 9, the lighting device 100C further has the frame 2 sandwiching and supporting outer edges of the lighting unit of the lighting device 100C. With the lighting device 100C, the first frame parts 20, the linking component 30 and the bolts 60 are shared with the two-by-two lighting device 100 discussed above. The second frame parts 40, meanwhile, is provided with straight sections 41B of a length corresponding to three times the length L5 of the light emitting units 1 in the X direction (see FIG. 5). In other words, the frame 2 has the second frame parts 40 each having the straight section 41B and the connectors 42 (see FIG. 5). With three columns, two of the linking components 30 are provided.

As shown in FIG. 10, a lighting device 100D includes three light emitting units 1 arranged in a layout of one row and three columns. In this example, the three light emitting units 1 form a lighting unit of the lighting device 100D. As shown in FIG. 10, the lighting device 100D further has the frame 2 sandwiching and supporting outer edges of the lighting unit of the lighting device 100D. With the lighting device 100D, the first frame parts 20A, the linking component 30A, and the bolts 60A are shared with those of the lighting device 100A with a layout of one row and two columns as shown in FIG. 7 and the lighting device 100B with a layout of one row and one column as shown in FIG. 8. The second frame parts 40, meanwhile, share the straight sections 41B with those of the lighting device 100C with a layout of two rows and three columns as shown in FIG. 9).

Thus, in this embodiment, many different variations with different numbers of light emitting units (that is, different amounts of light from the lighting device) can be configured merely by readying first frame parts, linking components, bolts, and straight sections according to the number of rows (in the Y direction) and columns (in the X direction) of light emitting units 1 to be arranged. The variations given above (e.g., the lighting devices 100A to 100D) are just examples, and other numbers of rows and columns besides those given above are also possible.

In this embodiment, as discussed above, the frame 2 is provided to sandwich and support the outer edges of the light emitting units 1, which allows the light emitting units 1 to be attached to the frame 2 merely by clamping the light emitting units 1 with the frame 2. Consequently, there is no need to perform the job of tightening bolts between the light emitting units 1 and the frame 2. Therefore, the work of assembling the light emitting units 1 and the lighting device 100 can be simplified. As a result, there is no need to provide bolts for attaching the light emitting units 1. Thus, an increase in the number of parts can be avoided.

Also, in this embodiment, as discussed above, the parts of the frame 2 (the pair of the second frame parts 40) are fastened together so as to sandwich the outer edges of the light emitting units 1 from the outside. With this configuration, the light emitting units 1 can be fixed to the frame 2 merely by fastening the parts of the frame 2 together. Thus, there is no need to use numerous screws, as opposed to when the light emitting units 1 are individually screwed to the frame 2.

Also, in this embodiment, as discussed above, the first frame parts 20, which are disposed on both sides in the X direction with respect to the light emitting units 1, and the second frame parts 40, which are disposed on both sides in the Y direction with respect to the light emitting units 1, are provided to the frame 2. The pair of second frame parts 40 is fastened together so as to sandwich the outer edges of the light emitting units 1 from the outside. With this configuration, the light emitting units 1 can be supported and fixed from both sides in the Y direction by the second frame parts 40. Thus, the light emitting units 1 can be supported easily and stably without the use of bolts for attaching the light emitting units.

Also, in this embodiment, as discussed above, the first frame parts 20 and the second frame parts 40 are linked together. With this configuration, the first frame parts 20 on both sides in the X direction with respect to the light emitting units 1, and the second frame parts 40 on both sides in the Y direction can be linked and fixed to each other. Thus, the outer edges of the light emitting units 1 can be surrounded and securely supported. Also, the first frame parts 20 and the second frame parts 40 are linked and integrated. Thus, the light emitting units 1 and the entire frame 2 can be engaged just by engaging the first frame parts 20 with the light emitting units 1.

Also, in this embodiment, as discussed above, the first frame parts 20 are configured so that they can be engaged with the outer edges (female components 16) of the light emitting units 1. With this configuration, the frame 2 and the light emitting units 1 can be engaged. Thus, the light emitting units 1 can be supported more reliably by the frame 2.

Also, in this embodiment, as discussed above, the first frame parts 20 and the outer edges of the light emitting units 1 are configured so that they can be engaged together by engagement of the male components 21 and the female components 16. The female components 16 are formed in a tapered cross sectional shape. The Male components 21 are formed in a tapered cross sectional shape corresponding to the tapered cross sectional shape of the female components 16. With this configuration, the first frame parts 20 and the outer edges (female components 16) of the light emitting units 1 can be easily engaged by fitting together the male components 21 and the female components 16. Also, since mating of the male components 21 and the female components 16 results in planar contact, the light emitting units 1 can be fixed more stably to the frame 2.

Also, in this embodiment, as discussed above, the light emitting units 1 are formed in a rectangular shape, and the female components 16 are disposed on both sides in the X direction. The male components 21, which engaged with the female components 16 in the X direction, are provided to the first frame parts 20. With this configuration, the light emitting units 1 can be reliably fixed by engaging the first frame parts 20 on both sides of the light emitting units 1 with the outer edges (female components 16) of the outside of the light emitting units 1.

Also, in this embodiment, as discussed above, the female components 16 are provided extending in the Y direction along the outer edges of the light emitting units 1, and the male components 21 are provided extending along the Y direction so as to correspond to the female components 16. With this configuration, the region of engagement between the female components 16 and the male components 21 becomes larger. Thus, the light emitting units 1 can be supported more reliably and stably. Also, since relative movement of the light emitting units 1 is possible in the Y direction in the engaged state, the light emitting units 1 can be attached to the frame 2 so as to slide in the Y direction during assembly of the light emitting units 1.

Also, in this embodiment, as discussed above, the light emitting units 1 each include the aluminum support member 13 and the heat dissipating fins 14. The female components 16 are integrally formed with the support member 13. The support member 13 supports the LED elements 11a and the substrate 12. The heat dissipating fins 14 are formed on the support member 13. The heat generated by the light emitting units 1 can be efficiently dissipated by the support member 13, which is made of aluminum having high thermal conductivity, and the heat dissipating fins 14 provided to the support member 13. The amount of heat generated by the light emitting units 1 is greater in tunnel lighting applications that required a large amount of light. Thus, the increase in heat dissipation provided by the aluminum support member 13 and the heat dissipating fins 14 is especially efficient. Also, in this embodiment, the male components 21 are formed integrally on the aluminum first frame parts 20. Thus, the heat generated by the light emitting units 1 can escape to the support member 13 and the first frame parts 20 through contact or engagement between the support member 13 and the first frame parts 20 that are made of aluminum with high thermal conductivity. This improves the overall heat dissipation of the lighting device 100.

Also, in this embodiment, as discussed above, the plurality of the light emitting units 1 is arranged in the X direction. The linking component 30 is disposed on the frame 2 between the plurality of light emitting units 1 such that the linking component 30 is engaged with the adjacent light emitting units 1 in the X direction. The plurality of light emitting units 1 is linked by the linking component 30. The outer edges on the Y direction side of the light emitting units 1 are sandwiched and supported by the pair of the second frame parts 40. With this configuration, the linking component 30 that links the adjacent light emitting units 1 allows the number of light emitting units 1 to be adjusted as desired. Also, even when the plurality of light emitting units 1 are provided, the light emitting units 1 can be supported stably, without using bolts for attaching the light emitting units, by merely clamping the light emitting units 1 within the second frame parts 40.

Also, in this embodiment, as discussed above, the plurality of light emitting units 1 are arranged in an overall rectangular shape in the X and Y directions. The first frame parts 20 are formed in a length corresponding to the overall length in the X direction of the plurality of light emitting units 1 arranged in a rectangular shape. The second frame parts 40 are formed in a length corresponding to the overall length in the Y direction of the plurality of light emitting units 1 arranged in a rectangular shape. With this configuration, variations of the lighting device 100, such as the lighting devices 100A to 100D, with different numbers of the light emitting units 1 are possible by merely preparing the first frame parts 20 and the second frame parts 40 with different length as desired. Consequently, variations of the lighting device 100 that allow the amount of light (that is, the number of light emitting units) required for an application to be obtained can be easily provided.

Also, in this embodiment, as discussed above, the LED elements 11a are provided as light emitting elements. With this configuration, the lighting device 100 can be obtained that has a long service life and low power consumption.

Also, in this embodiment, as discussed above, the lighting device 100 is provided for lighting a tunnel. Since a large amount of light is required in tunnel lighting applications, a relatively large lighting device is necessary. Accordingly, when light emitting units were attached with bolts as in the past, the increased size of the light emitting units (or the increase in the number of units) drove up the labor entailed by attachment and the number of bolts that were used. Therefore, applying the present invention to the lighting device 100 for lighting a tunnel is particularly effective in terms of minimizing the increase in the number of parts and of simplifying the job of attaching the light emitting units 1.

The embodiment disclosed herein is just an example in every respect, and should not be interpreted as being limiting in nature. The scope of the invention being indicated by the appended claims rather than by the above description of the embodiments, all modifications within the meaning and range of equivalency of the claims are included.

For example, in the above embodiment, the lighting device 100 is applied for lighting a tunnel. However, the present invention is not limited to this. The present invention can also be applied to a lighting device used for something other than lighting a tunnel.

Also, in the above embodiment, an aluminum frame (first frame parts, second frame parts, and linking component) and aluminum support members are used. However, the present invention is not limited to this. For instance, these members can be made of a metal material other than aluminum that has good thermal conductivity. A material other than a metal material can also be used, so long as it has adequate thermal conductivity and mechanical strength.

Also, in the above embodiment, the second frame parts sandwiches the light emitting units. However, the present invention is not limited to this. With the present invention, the first frame parts can sandwich the light emitting units, or the first frame parts and the second frame parts can both sandwich the light emitting units.

Also, in the above embodiment, the first frame parts are engaged with the outer edges of the light emitting units. However, the present invention is not limited to this. With the present invention, the second frame parts can be engaged with the outer edges of the light emitting units. Also, the first frame parts and the second frame parts can both be engaged with the outer edges of the light emitting units.

Also, in the above embodiment, the male components are formed on the first frame parts and the linking component, and the male components are engaged with the female components formed in the support members of the light emitting units. However, the present invention is not limited to this. With the present invention, the female components can be formed in the first frame parts and the linking component, and the male components can be formed in the support members.

Also, in the above embodiment, the male components of the first frame parts and the linking component are engaged with the female components of the support members of the light emitting units. However, the present invention is not limited to this. With the present invention, the first frame parts and the linking component can be engaged with the light emitting units by some configuration other than the combination of the male components and the female components. For instance, this engagement can be accomplished by fitting pins into holes.

Also, in the above embodiment, the male components of the first frame parts and the linking component and the female components of the support members of the light emitting units are formed extending over the entire length of these components in the Y direction. However, the present invention is not limited to this. The male components and the female components can be formed partially. Specifically, the male components can be formed partially on just a part of the first frame parts and the linking component. The female components can be formed partially on just a part of the light emitting units. Furthermore, a plurality of male components and female components that are formed partially can also be provided.

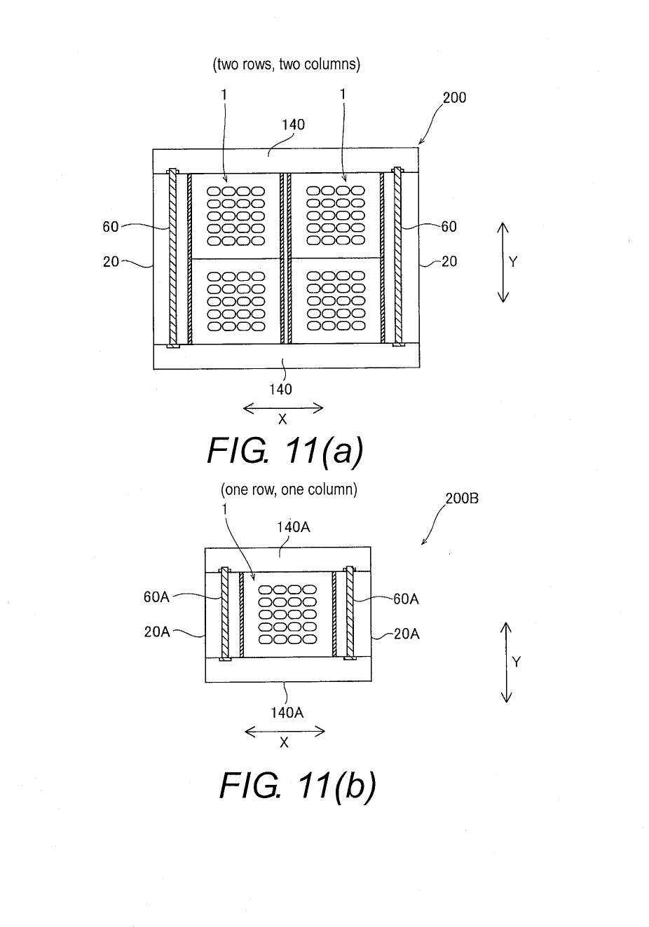

Also, in the above embodiment, each of the second frame parts is made up of one straight section and two connectors (three members). However, the present invention is not limited to this. With the present invention, the second frame part can be formed by a single member as in the modification example shown in FIGS. 11(a) and 11(b).

As shown in FIG. 11(a), a lighting device 200 in the modification example has four light emitting units 1 arranged in two rows and two columns. The lighting device 200 has a pair of the first frame parts 20 (see FIG. 5) and a pair of second frame parts 140. Each of the second frame parts 140 is formed by a single member. The second frame parts 140 are disposed on both sides in the Y direction with respect to the light emitting units 1 and the first frame parts 20. The various components, including the light emitting units 1, are clamped together by pulling the second frame parts 140 on both sides toward each other from both sides in the Y direction with the bolts 60 and the nuts 61 (see FIG. 5). As shown in FIG. 11(b), again in this modification example, a lighting device 200B with a different number of the light emitting units 1 can be configured by providing a pair of second frame parts 140A having a different length. The lighting device 200B has a pair of the first frame parts 20A (see FIGS. 7, 8 and 10) and the second frame parts 140A. With this configuration, the various components, including the light emitting units 1, are clamped together by pulling the second frame parts 140A on both sides toward each other from both sides in the Y direction with the bolts 60A (see FIGS. 7, 8 and 10) and the nuts 61 (see FIG. 5).

Also, in the above embodiment, the pair of the second frame parts is fastened together by the long bolts 60 that pass through the hollow first frame parts, and the nuts 61 that is thread onto the bolts 60. However, the present invention is not limited to this. With the present invention, the second frame parts and first frame parts can be fastened together by providing threaded holes in the first frame parts and threading bolts into these holes. In this case, the length of the first frame parts is decided so that the second frame parts exert the proper force on the light emitting units in the Y direction.

Also, in the above embodiment, the light emitting units are provided with LED elements. However, the present invention is not limited to this. For example, light emitting elements other than LED elements, such as fluorescent tubes, can be provided.

Also, in the above embodiment, the heat dissipating fins are provided to the support members of the light emitting units. However, the present invention is not limited to this. With the present invention, pin-shaped heat dissipating components can be provided instead of the heat dissipating fins. Also, the heat dissipating fins need not be provided.

The lighting device pertaining to one aspect includes a lighting unit and a frame. The lighting unit has at least one light emitting unit with light emitting elements. The frame sandwiches outer edges of the lighting unit to support the lighting unit.

With the lighting device pertaining to one aspect, as discussed above, the frame that sandwiches and supports the outer edges of the lighting unit having the light emitting unit is provided. Thus, the light emitting unit can be attached to the frame merely by clamping the light emitting unit with the frame. Consequently, there is no need for the work of bolting the light emitting unit to the frame. Thus, the job of assembling the light emitting unit can be simplified. As a result, there is no need to provide bolts for attaching the light emitting unit. Thus, an increase in the number of parts can be avoided.

With the lighting device pertaining to the above aspect, the frame includes frame parts that are linked together. The frame parts sandwiches the outer edges of the lighting unit from outside. With this configuration, the light emitting unit can be fixed to the frame merely by fastening the frame parts together. Thus, there is no need to use numerous screws, as opposed to when individual light emitting units are each screwed to a frame.

In this case, the frame parts further include a pair of first frame parts and a pair of second frame parts. The first frame parts are disposed on both sides in a first direction with respect to the lighting unit. The second frame parts are disposed on both sides in a second direction perpendicular to the first direction with respect to the lighting unit. One of the pairs of the first frame parts and the second frame parts is linked together such that the one of the pairs of the first frame parts and the second frame parts sandwiches the outer edges of the lighting unit from the outside. With this configuration, the light emitting unit can be sandwiched, supported, and fixed from both sides by one of the first frame parts and the second frame parts. Thus, the light emitting unit can be supported easily and stably without the use of bolts for attaching the light emitting unit.

With the above-mentioned configuration in which the first frame parts and second frame parts are included, the first frame parts and the second frame parts are linked to each other. With this configuration, the first frame parts on both sides in the first direction with respect to the lighting unit and the second frame parts on both sides in the second direction can be linked and mutually fixed. Thus, the outer edges of the lighting unit can be securely supported such that the outer edges are surrounded.

With the configuration in which the frame includes the first frame parts and the second frame parts, the other one of the pairs of the first frame parts and the second frame parts is engaged with outer engagement edges of the light emitting unit. With this configuration, since the frame and the light emitting unit can be engaged, the light emitting unit can be more reliably supported by the frame.

In this case, the other one of the pairs of the first frame parts and the second frame parts is engaged with the outer engagement edges of the lighting unit by engaging male and female components, the female components have a tapered cross sectional shape. The male components have a tapered cross sectional shape that corresponds to the tapered cross sectional shape of the female components. With this configuration, the other one of the pairs of the first frame parts and the second frame parts can be easily engaged with the outer engagement edges of the lighting unit by mating the male components and the female components. Also, since the mating of the tapered female components and the tapered male components results in planar contact, the light emitting unit can be fixed to the frame more stably.

With a configuration in which the other one of the pairs of the first frame parts and the second frame parts can be engaged with the outer engagement edges of the lighting unit, the light emitting unit includes first engagement components disposed on both sides in the first direction with respect to the light emitting unit. The light emitting unit has a rectangular shape. The first frame parts include second engagement components, respectively. One of the second engagement components is engaged with one of the first engagement components in the first direction. With this configuration, the light emitting unit can be reliably fixed by engaging the first frame parts on both sides of the lighting unit with the outer engagement edges on the outside of the lighting unit.

In this case, the one of the first engagement components extends along one of the outer engagement edges of the lighting unit. The one of the second engagement components is arranged to correspond to the one of the first engagement components. With this configuration, the engagement region between the first engagement components and the second engagement components becomes larger. Thus, the light emitting unit can be supported more reliably and stably.

With a configuration in which the light emitting unit includes the first engagement components and the first frame parts include the second engagement components, the light emitting unit includes a metal support member and heat dissipating fins. The support member is formed integrally with the first engagement components and supports the light emitting elements. The heat dissipating fins are provided to the support members. With this configuration, heat generated by the light emitting unit can be efficiently dissipated by the heat dissipating fins provided to the support member and by the metal support member themselves, which generally have high thermal conductivity. The increase in heat dissipation by the metal support member and the heat dissipating fins will be particularly effective in applications that require a large amount of light, since more heat is generated by the light emitting unit.

With a configuration in which the frame includes the first frame parts and the second frame parts, the lighting unit has a plurality of light emitting units. The light emitting units are arranged in the first direction. The frame further includes a linking frame that is disposed between an adjacent pair of the light emitting units. The linking frame is engaged with the adjacent pair of the light emitting units in the first direction such that the adjacent pair of the light emitting units is linked by the linking frame. The outer edges of the lighting unit are defined by portions of an outer periphery of the light emitting units. The outer edges of the lighting unit are sandwiched and supported by the one of the pairs of the first frame parts and the second frame parts. With this configuration, the number of the light emitting units can be freely adjusted by means of the linking frame that links adjacent light emitting units. Also, even when the plurality of light emitting units are provided, if the outer edges located outside of the plurality of light emitting units are sandwiched by the one of the pairs of the first frame parts and the second frame parts, the light emitting units can be supported stably without having to use bolts for attaching the light emitting units.

With a configuration in which the frame includes the first frame parts and the second frame parts, the lighting unit has a plurality of light emitting units. The light emitting units are arranged in a rectangular shape in the first direction and the second direction. The first frame parts have a length corresponding to an overall length of the rectangular shape in the first direction. The second frame parts have a length corresponding to an overall length of the rectangular shape in the second direction. With this configuration, a wide variety of lighting devices with different numbers of light emitting units can be configured merely by readying a plurality of types of first frame parts and second frame parts. Consequently, it is easy to provide a variety of lighting devices capable of producing the amount of light (that is, the number of light emitting units) required by the application.

With the lighting device pertaining to the above aspect, each of the light emitting elements includes an LED. With this configuration, a lighting device with a long service life and low power consumption can be obtained.

With the lighting device pertaining to the above aspect, the lighting device forms a lighting device for lighting a tunnel. Since a large amount of light is required in tunnel lighting applications, the lighting device needs to be relatively large in size. Therefore, when bolts are used to attach the light emitting units to the frames as in the past, the larger size of the light emitting units (or an increase in the number of units) leads to more bolts being used and more assembly steps being entailed. Accordingly, if the present invention is applied to a lighting device used for lighting a tunnel, an increase in the number of parts can be avoided. Thus, the work involved in assembling the light emitting units can be simplified.

As discussed above, with the present invention, a lighting device can be obtained with which an increase in the number of parts is avoided and the work entailed by assembling light emitting units can be simplified.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

While only a preferred embodiment has been chosen to illustrate the present invention, it will be apparent to those skilled in the art from this disclosure that various changes and modifications can be made herein without departing from the scope of the invention as defined in the appended claims. Furthermore, the foregoing descriptions of the embodiment according to the present invention are provided for illustration only, and not for the purpose of limiting the invention as defined by the appended claims and their equivalents.

What is claimed is:

1. A lighting device comprising:
a lighting unit having at least one light emitting unit with light emitting elements; and
a frame sandwiching outer edges of the lighting unit to support the lighting unit.

2. The lighting device according to claim 1, wherein
the frame includes frame parts that are linked together, the frame parts sandwiching the outer edges of the lighting unit from outside.

3. The lighting device according to claim 2, wherein
the frame parts includes a pair of first frame parts disposed on both sides in a first direction with respect to the lighting unit, and a pair of second frame parts disposed on both sides in a second direction with respect to the lighting unit, the second direction being perpendicular to the first direction, and
one of the pairs of the first frame parts and the second frame parts is linked together such that the one of the pairs of the first frame parts and the second frame parts sandwiches the outer edges of the lighting unit from the outside.

4. The lighting device according to claim 3, wherein
the first frame parts and the second frame parts are linked together.

5. The lighting device according to claim 3, wherein
the other one of the pairs of the first frame parts and the second frame parts is engaged with outer engagement edges of the lighting unit.

6. The lighting device according to claim 5, wherein
the other one of the pairs of the first frame parts and the second frame parts is engaged with the outer engagement edges of the lighting unit by engaging male and female components, the female components having a tapered cross sectional shape, the male components having a tapered cross sectional shape corresponding to the tapered cross sectional shape of the female components.

7. The lighting device according to claim 5, wherein
the light emitting unit includes first engagement components disposed on both sides in the first direction with respect to the light emitting unit, the light emitting unit having a rectangular shape, and
the first frame parts include second engagement components, respectively, one of the second engagement components being engaged with one of the first engagement components in the first direction.

8. The lighting device according to claim 7, wherein
the one of the first engagement components extends along one of the outer engagement edges of the lighting unit, and
the one of the second engagement components is arranged to correspond to the one of the first engagement components.

9. The lighting device according to claim 7, wherein
the light emitting unit includes a metal support member that is formed integrally with the first engagement components and supports the light emitting elements, and heat dissipating fins that are provided to the support members.

10. The lighting device according to claim 3, wherein
the lighting unit has a plurality of light emitting units, the light emitting units being arranged in the first direction,
the frame further includes a linking frame that is disposed between an adjacent pair of the light emitting units, the linking frame being engaged with the adjacent pair of the light emitting units in the first direction such that the adjacent pair of the light emitting units is linked by the linking frame, and
the outer edges of the lighting unit are defined by portions of an outer periphery of the light emitting units, the outer edges of the lighting unit are sandwiched and supported by the one of the pairs of the first frame parts and the second frame parts.

11. The lighting device according to claim 3, wherein
the lighting unit has a plurality of light emitting units, the light emitting units being arranged in a rectangular shape in the first direction and the second direction,
the first frame parts have a length corresponding to an overall length of the rectangular shape in the first direction, and
the second frame parts have a length corresponding to an overall length of the rectangular shape in the second direction.

12. The lighting device according to claim 1, wherein
each of the light emitting elements includes an LED.

13. The lighting device according to claim 1, wherein
the lighting device forms a lighting device for lighting a tunnel.
